(19) United States
(12) Patent Application Publication
(10) Pub. No.: US 2012/0026185 A1
(43) Pub. Date: Feb. 2, 2012

(54) DISPLAY APPARATUS AND DISPLAY METHOD

(76) Inventors: Yoshiaki Owaki, Osaka (JP); Tomoe Ogawa, Kanagawa (JP); Mitsuhiro Mori, Osaka (JP)

(21) Appl. No.: 13/264,051

(22) PCT Filed: Apr. 13, 2010
(86) PCT No.: PCT/JP2010/002661

§ 371 Date: Oct. 12, 2011

(30) Foreign Application Priority Data
Apr. 14, 2009 (JP) 2009-097941

(51) Int. Cl. G09G 5/02

(52) U.S. Cl. 345/589

(57) ABSTRACT

A display device prevents the display screen from flickering even when the display mode changes automatically. The display device has plural modes, a viewing environment detector that detects the ambient brightness and changes the mode based on the detected ambient brightness, a screen brightness calculator that calculates the brightness of the display screen in each mode based on the average brightness of video data in one frame, and a screen brightness merger that, when the mode changes, gradually changes the brightness of the display screen from the brightness of the display screen before the mode change to the brightness of the display screen after the mode change.

### BACKGROUND OF THE INVENTION

(1) Field of the Invention

The present invention relates to a display apparatus (or device) and a display method for a display panel such as a plasma display panel (PDP), and relates more particularly to a display device having a plurality of modes and a display method for the display device.

(2) Description of Related Art

Display devices that use a display panel such as a plasma display panel have become widely used in recent years due, in part, to their small footprint. Japanese Unexamined Patent Appl. Pub. JP-A-H 11-231825 teaches a display device that can adjust and emphasize images according to the average brightness (APL: Average Picture Level) of the video data in one frame. This enables high fidelity image reproduction. Japanese Unexamined Patent Appl. Pub. JP-A-2006-238255 and WIPO Pub. No. WO/2008/105179 teach a display device that has plural modes. When set to the mode for a bright ambient environment, this display device can increase image contrast and increase image brightness.

The followings are the related prior art documents.

Japanese Patent Publication No. JPA H11-231825
Japanese Patent Publication No. JPA 2006-238255
WIPO Publication No. WO/2008/105179

With the display device according to the related art described above, however, the user must set the mode manually. The mode can, however, be set automatically by incorporating a sensor that detects the ambient brightness. However, the brightness of the display screen changes abruptly when the mode changes, and this can be visually disturbing for the viewer. This abrupt change in display brightness is referred to below as “flicker.”

### BRIEF SUMMARY OF THE INVENTION

A display device and a display method according to the present invention solve this problem by enabling automatically changing the display mode according to the ambient brightness without causing the display screen to flicker.

A first aspect of the invention is a display device that has plural display modes, and has a screen brightness calculator that calculates the brightness of the display screen in each mode based on the average brightness of video data in one frame; and a screen brightness merger that, when the mode changes, gradually changes the brightness of the display screen from the brightness of the display screen before the mode change to the brightness of the display screen after the mode change.

A display device according to another aspect of the invention also has a viewing environment detector that detects the ambient brightness and changes the mode based on the detected ambient brightness.

In a display device according to another aspect of the invention, the screen brightness merger changes the brightness of the display screen from the brightness before the mode change to the brightness of the display screen after the mode change over a specified time.

In a display device according to another aspect of the invention, the screen brightness merger adjusts the time used to change the brightness of the display screen from the brightness of the display screen before the mode change to the brightness of the display screen after the mode change according to the average brightness of the video data in one frame.

In a display device according to another aspect of the invention, the screen brightness merger adjusts the time used to effect the change when the average brightness of video data in one frame is greater than or equal to a first specific value to shorter than the time used to effect the change when the average brightness of video data in one frame is less than the first specific value.

In a display device according to another aspect of the invention, the screen brightness merger adjusts the time used to change the brightness of the display screen from the brightness of the display screen before the mode change to the brightness of the display screen after the mode change according to the difference between the brightness of the display screen before the mode change and the brightness of the display screen after the mode change.

In a display device according to another aspect of the invention, the screen brightness merger adjusts the time used to effect the change when the difference between the brightness of the display screen before the mode change and the brightness of the display screen after the mode change is greater than or equal to a second specific value to longer than the time used to effect the change when the average brightness of video data in one frame is less than the second specific value.

In a display device according to another aspect of the invention, the screen brightness merger adjusts the time used to change the brightness of the display screen from the brightness of the display screen before the mode change to the brightness of the display screen after the mode change according to a frequency component of the video data.

In a display device according to another aspect of the invention, the screen brightness merger adjusts the time used to effect the change when the frequency component of the video data is greater than or equal to a third specific value to shorter than the time used to effect the change when the frequency component of the video data is less than the third specific value.

In a display device according to another aspect of the invention, the screen brightness merger immediately changes the brightness of the display screen from the brightness of the display screen before the mode change to the brightness of the display screen after the mode change when the mode is changed manually.

Another aspect of the invention is a display method for a display device that has plural display modes, including a screen brightness calculation step of calculating the brightness of the display screen in each mode based on the average brightness of video data in one frame, and a screen brightness merging step of gradually changing the brightness of the display screen from the brightness of the display screen before the mode change to the brightness of the display screen after the mode change when the mode changes.

### EFFECT OF THE INVENTION

A display device and display method according to the invention detect the ambient brightness and automatically change the mode according to the detected brightness. As a result, the user does not need to manually set the mode. The display screen can also be prevented from flickering when the mode changes by causing the brightness of the display screen to change gradually.

Other objects and attainments together with a fuller understanding of the invention will become apparent and appreciated by referring to the following description and claims taken in conjunction with the accompanying drawings.

### BRIEF DESCRIPTION OF THE SEVERAL VIEWS OF THE DRAWINGS

FIG. 1 is a block diagram showing the configuration of a display device according to a first embodiment of the invention.

FIG. 2 is a block diagram showing the configuration of the image feature evaluation unit 106.

FIG. 3 is a flow chart of the first mode multiple calculation process of a display device according to the first embodiment of the invention.

FIG. 4 shows an example of a first mode multiple table of the first mode multiple calculator 115 shown in FIG. 2.

FIG. 5 is a flow chart of the multiple merging process of a display device according to the first embodiment of the invention.

FIG. 6 is a flow chart of the parameter number calculation process of a display device according to the first embodiment of the invention.

FIG. 7 shows examples of first and second mode parameter number tables used by the parameter number calculator 118 shown in FIG. 2.

FIG. 8 shows an example of a parameter table of the parameter setting unit 114 shown in FIG. 2.

FIG. 9 shows an example of the multiple change when the ambient brightness of the display device does not change.

FIG. 10 shows an example of the multiple change when the ambient brightness of the display device changes.

FIG. 11 shows the multiple change from frame 30 to frame 90 in FIG. 10.

FIG. 12 shows an example of the multiple change when the multiple of the second mode changes while the multiple is changing.

FIG. 13 is a block diagram showing the configuration of a display device according to a second embodiment of the invention.

FIG. 14 describes a method whereby the frequency calculator shown in FIG. 13 calculates the frequency component.

FIG. 15 is a block diagram showing the configuration of the number setting unit 113A in FIG. 13 in detail.

FIG. 16 is a block diagram showing the configuration of the correction calculator 121 in FIG. 15.

FIG. 17 shows an example of a function of the first calculator and second calculator in FIG. 16.

FIG. 18 is a flow chart of the multiple merging process of a display device according to the second embodiment of the invention.

### DETAILED DESCRIPTION OF THE INVENTION

Preferred embodiments of display device according to the present invention are described below with reference to the accompanying figures. Note that like parts are identified by like reference numerals in the embodiments described below.

### Embodiment 1

This embodiment of the invention describes a display device that detects the ambient brightness of the display device, automatically changes the mode based on the detected ambient brightness, and when changing the mode gradually changes the brightness of the display screen from the brightness of the display screen before the mode change to the brightness of the display screen after the mode change.

### Display Device Configuration

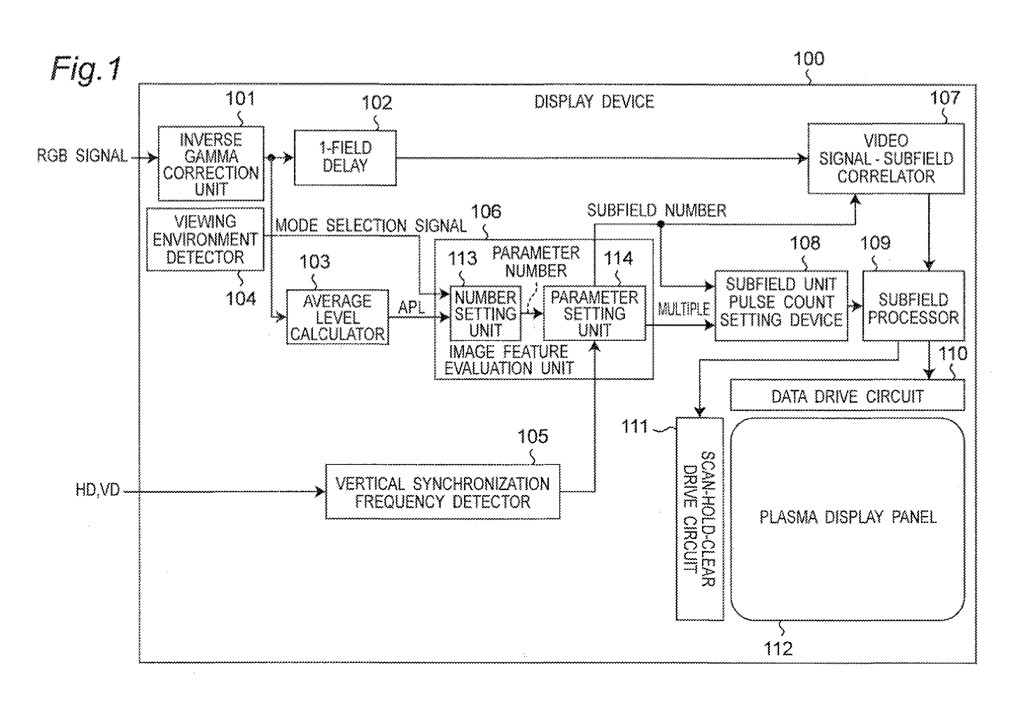

FIG. 1 is a block diagram showing the configuration of a display device according to a first embodiment of the invention. As shown in FIG. 1, a display device 100 according to this embodiment of the invention has an inverse gamma correction unit 101, 1-field delay 102, average level calculator 103, viewing environment detector 104, vertical synchronization frequency detector 105, image feature evaluation unit 106, video signal—subfield correlator 107, subfield unit pulse count setting device 108, subfield processor 109, data drive circuit 110, scan-hold-clear drive circuit 111, and plasma display panel 112.

The inverse gamma correction unit 101 applies inverse gamma correction to the RGB signal input to the display device 100. The 1-field delay 102 delays the inverse gamma corrected RGB signal one field.

The average level calculator 103 calculates the average level (APL: Average Picture Level) of the inverse gamma corrected RGB signal. More specifically, the average level calculator 103 calculates the sum of the R signals, G signals, and B signals in one frame, and based on the total of these three sums calculates the APL, which is the average brightness of that frame (that is, the average brightness of the video data in the one frame).

The viewing environment detector 104 has a sensor and detects the ambient brightness of the display device. The viewing environment detector 104 outputs mode selection signal 0 (first mode) when the ambient brightness of the display device is greater than or equal to a specified brightness (that is, is bright), and outputs mode selection signal 1 (second mode) when the ambient brightness is less than the specified brightness (that is, is dark). The first mode is a dynamic mode, and the second mode is a cinema mode, for example.

The vertical synchronization frequency detector 105 detects the vertical sync frequency based on the vertical sync signal input from input terminal HD.

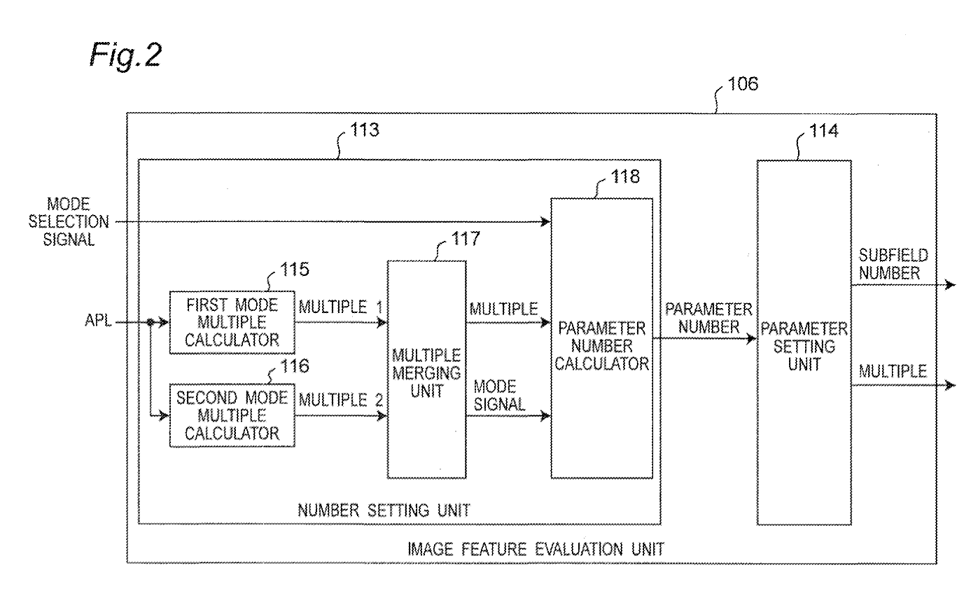

The image feature evaluation unit 106 includes a number setting unit 113 and parameter setting unit 114 (shown in FIG. 2).

The number setting unit 113 determines the parameter number based on the APL from the average level calculator 103 and the mode selection signal from the viewing environment detector 104. The parameter setting unit 114 determines the parameter based on the parameter number from the number setting unit 113. This parameter is the subfield number and multiple. The display screen is bright when this multiple is high, and the display screen is dark when the multiple is low.

The video signal—subfield correlator 107 correlates the signal delayed one field by the 1-field delay 102 with the subfield number from the image feature evaluation unit 106.

The subfield unit pulse count setting device 108 determines the number of hold pulses required in each subfield based on the subfield number and multiple from the image feature evaluation unit 106.

The subfield processor 109 determines the pulse signals required in the set-up period, write period, and hold period based on the hold pulse count required in each subfield from the subfield unit pulse count setting device 108, and outputs a PDP drive signal.

The data drive circuit 110 and scan-hold-clear drive circuit 111 display images on the plasma display panel 112 based on the PDP drive signal from the subfield processor 109.

FIG. 2 is a block diagram showing the configuration of the image feature evaluation unit 106 in FIG. 1 in detail. The image feature evaluation unit 106 includes a number setting unit 113 and parameter setting unit 114. The number setting unit 113 includes a first mode multiple calculator 115, second mode multiple calculator 116, multiple merging unit 117, and parameter number calculator 118.

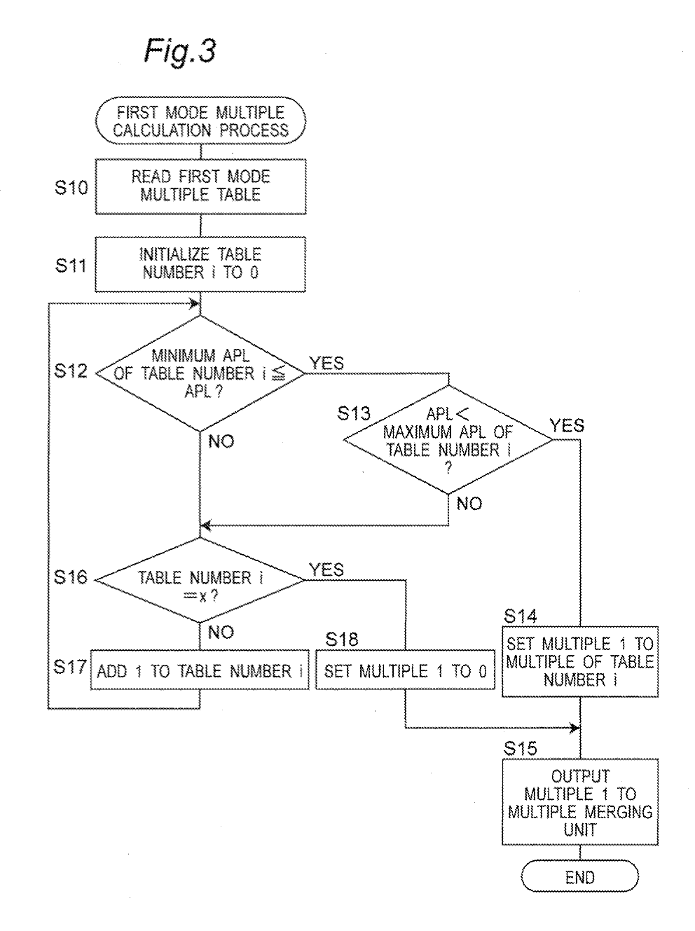

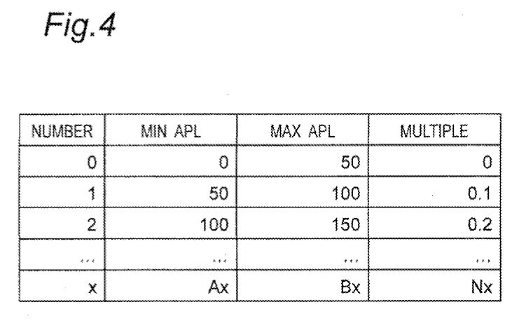

The first mode multiple calculator 115 calculates the first mode multiple (“multiple 1” below) based on the APL from the average level calculator 103. This is described more specifically with reference to FIG. 3 and FIG. 4.

FIG. 3 is a flow chart of the first mode multiple calculation process, and FIG. 4 is an example of a first mode multiple table used by the first mode multiple calculator 115. In FIG. 3 the first mode multiple calculator 115 reads the first mode multiple table shown in FIG. 4 (S10), initializes the table number i to 0 (S11), and then determines if the APL is greater than or equal to the minimum APL of table number i and less than the maximum APL (S12 and S13) of table number i. If the APL is greater than or equal to the minimum APL of table number i and less than the maximum APL of table number i (S12 returns Yes and S13 returns Yes), the multiple of table number i is set to multiple 1 (S14), the set multiple 1 is output to the multiple merging unit 117 (S15), and this process ends.

If the APL is not greater than or equal to the minimum APL of table number i (S12 returns No), or is not less than the maximum APL of table number i (S13 returns No), 1 is added to the table number i (S17), control returns to step S12, and the process repeats until the table number i reaches a specific value×(S16 returns No). If the table number i reaches the specific value×(S16 returns Yes), a multiple for the APL is not in the table, the multiple 1 is therefore set to 0 (S18), the set multiple 1 is output to the multiple merging unit 117 (S15), and this process ends.

Operation when the APL is 120 is described with reference to FIG. 4. Because the APL (120) is greater than or equal to the minimum APL (100) in table number 2, and is less than the maximum APL (150) in table number 2, the multiple 1 is set to the multiple, 0.2, for table number 2 (step S14 in FIG. 3).

The second mode multiple calculator 116 similarly calculates the multiple of the second mode (multiple 2, below) based on the APL from the average level calculator 103. The second mode multiple calculation process is the same as the first mode multiple calculation process except that the second mode multiple calculator 116 uses a second mode multiple table, which is different from the first mode multiple table used by the first mode multiple calculator 115.

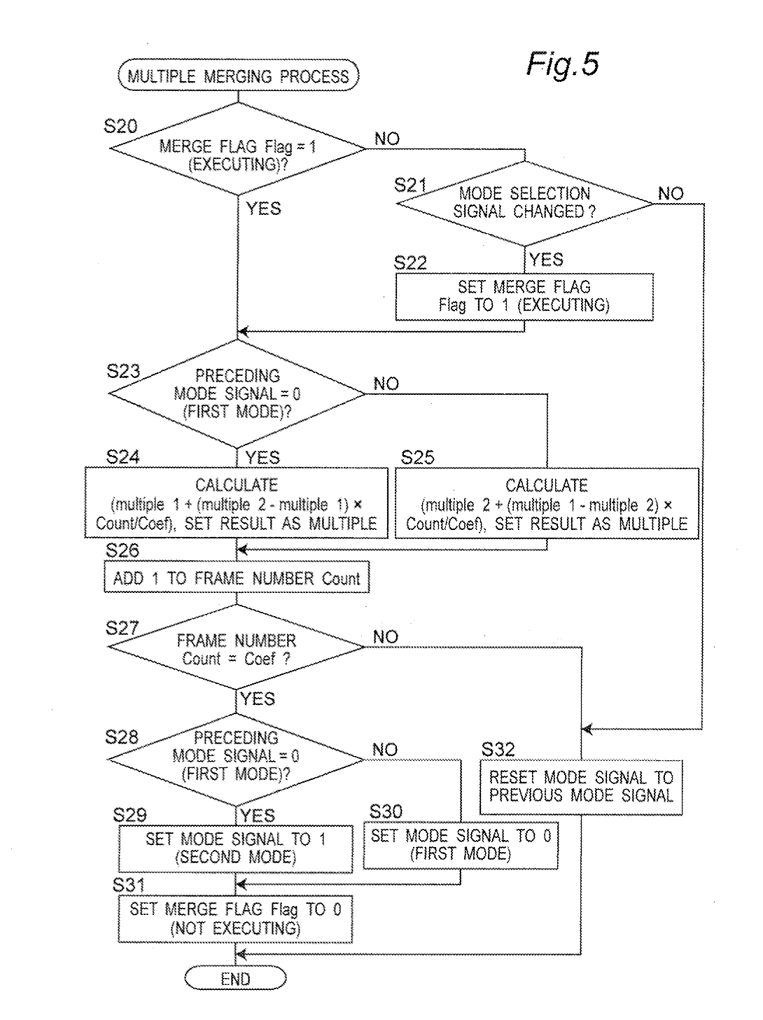

The multiple merging unit 117 calculates a multiple and mode signal based on multiple 1 from the first mode multiple calculator 115, multiple 2 from the second mode multiple calculator 116, and the mode selection signal. This is described with reference to FIG. 5.

FIG. 5 is a flow chart of the multiple merging process of the display device according to the first embodiment of the invention. The multiple merging unit 117 first determines if the merge flag Flag equals 1 (indicating the process is already running) (S20). If the merge flag Flag is 0 (the process is not running) (S20 returns No), the multiple merging unit 117 determines if there was a change in the mode selection signal (S21). If there was a change in the mode selection signal, the multiple merging unit 117 sets the merge flag Flag to 1 (executing) to start the merging process, and initializes the frame number Count to 0 (S22).

If the merge flag Flag is 1 (executing) in step S20, and after the merge process starts in step S22, the multiple merging unit 117 determines if the preceding mode signal was set to 0 (first mode) (S23). If the, preceding mode signal was 0 (first mode), the multiple is calculated and set as ((multiple 1+(multiple 2−multiple 1)×Count/Coef)) (S24). Coef is the frame count of the period for which the multiple is changed, and in this embodiment of the invention is a specific value, such as Coef=60. If in step S23 the previous mode signal was 1 (second mode), ((multiple 2+(multiple 1−multiple 2)×Count/Coef)) is calculated and set as the multiple (S25). The frame number Count is then incremented 1 (S26), and whether the frame number Count equals the Coef is determined (S27).

When the frame number Count reaches Coef, the merge process ends. More specifically, when the previous mode signal is 0 (first mode) (S28 returns Yes), the mode signal is set to 1 (second mode) (S29), when the previous mode signal is 1 (second mode) (S28 returns No), the mode signal is set to 0 (first mode) (S30), the merge flag Flag is finally set to 0 (not executing) (S31), and this process ends. When there is no change in the mode selection signal in step S21, or when the frame number Count reaches Coef in step S27, the mode signal is set to the previous mode signal (S32), and the flow chart ends.

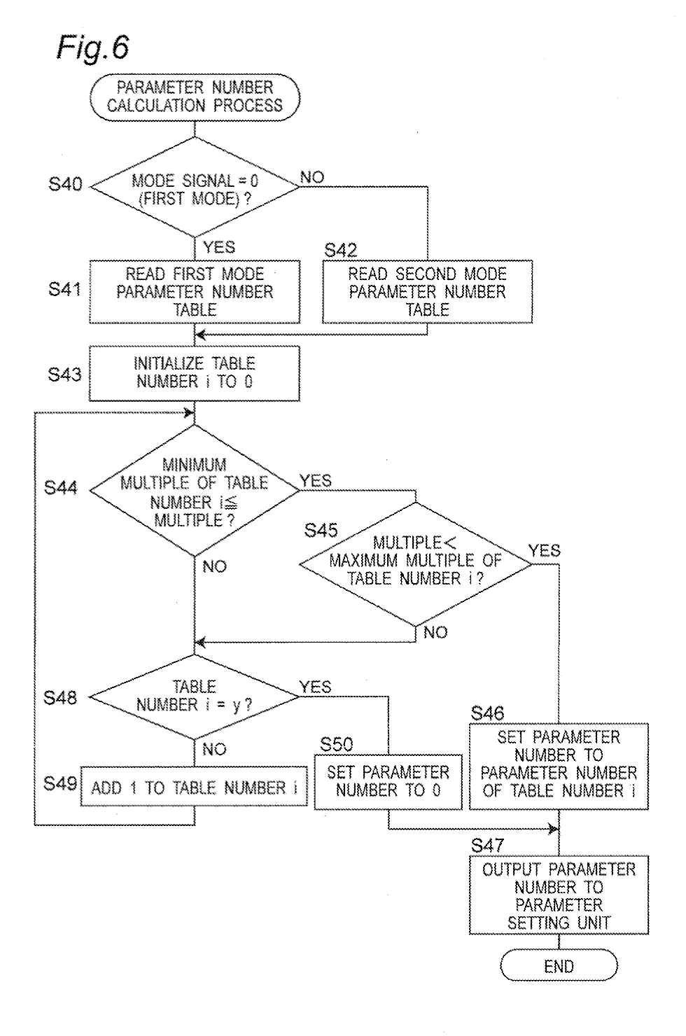

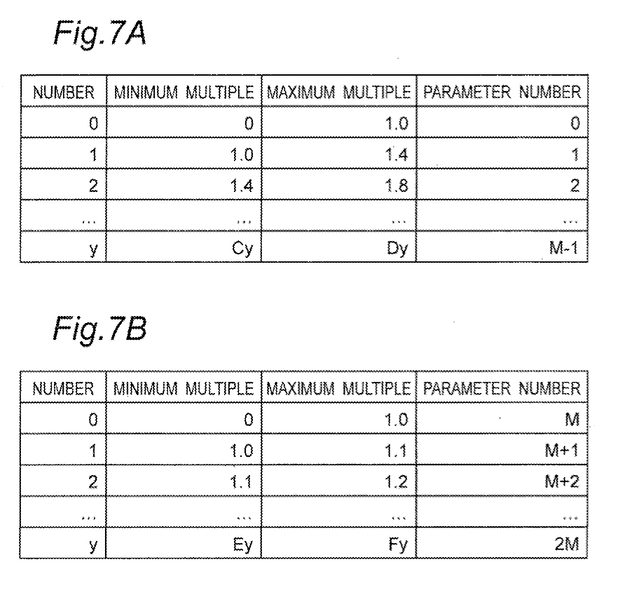

The parameter number calculator 118 calculates the parameter number based on the multiple and mode signal from the multiple merging unit 117. This is described more specifically with reference to FIG. 6 and FIG. 7.

FIG. 6 is a flow chart of the parameter number calculation process, FIG. 7A shows an example of a first mode parameter number table used by the parameter number calculator 118 in FIG. 2, and FIG. 7B shows an example of a second mode parameter number table used by the parameter number calculator 118 in FIG. 2.

Referring to FIG. 6, the parameter number calculator 118 determines if the mode signal is set to 0 (mode 1) (S40). If the mode signal is 0 (first mode), the parameter number calculator 118 reads the first mode parameter number table (FIG. 7(a)) (S41), and if the mode signal is 1 (second mode), reads the second mode parameter number table (FIG. 7(b)) (S42). The parameter number calculator 118 then sets the table number i to the default value 0 (S43), and then determines if the multiple is greater than or equal to the minimum multiple of table number i and less than the maximum multiple of table number i (S44 and S45).

If the average level APL of the RGB signal is greater than or equal to the minimum multiple of table number i and less than the maximum multiple of table number i (S44 returns Yes and S45 returns Yes), the parameter number is set to the parameter number of table number i (S46). The set parameter number is then output to the parameter setting unit 114 (S47), and this process ends.

If the multiple is not greater than or equal to the minimum multiple of table number i (S44 returns No), or is not less than the maximum multiple of table number i (S45 returns No), table number i is incremented by 1 (S49), control returns to step S44, and the process repeats until the table number i reaches specific value y (S48 returns No). When the table number i reaches the specific value y (S48 returns Yes), the parameter number is set to 0 (S50) because the parameter number corresponding to the multiple is not in the table. The set parameter number is then output to the parameter setting unit 114 (S47), and this process ends.

A case in which the mode signal is 0 (first mode) and the multiple is 1.1 is described next with reference to FIG. 7. Because the mode signal is 0 (first mode), the first mode parameter number table (FIG. 7(a)) is read (step S41 in FIG. 6). Because the multiple (1.1) is greater than or equal to the minimum multiple of table number 1 (1.0) and is less than the maximum multiple of table number 1 (1.4), the parameter number is set to the parameter number (1) of table number 1.

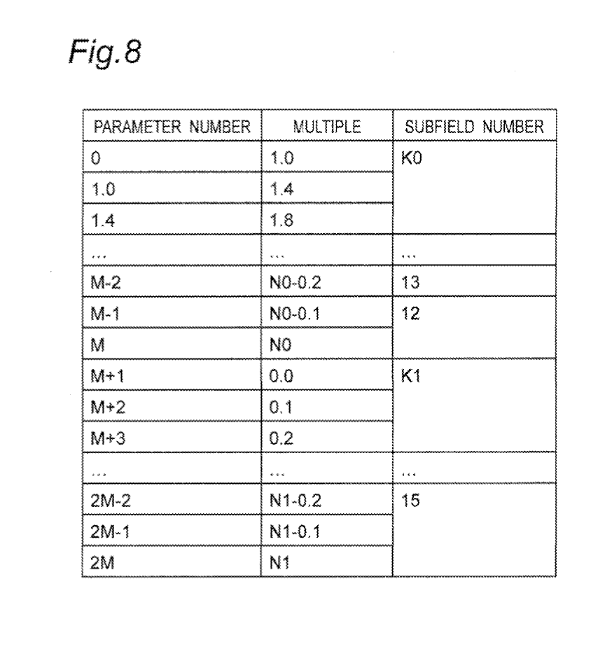

The parameter setting unit 114 has a parameter table, and determines the parameter based on the parameter number from the number setting unit 113. The parameters in this case are the subfield number and the multiple. FIG. 8 shows an example of the parameter table used by the parameter setting unit 114 in FIG. 2. When the parameter number is 1, for example, the multiple is set to 1.4, and the subfield number is set to K0.

### Example of a Multiple Change

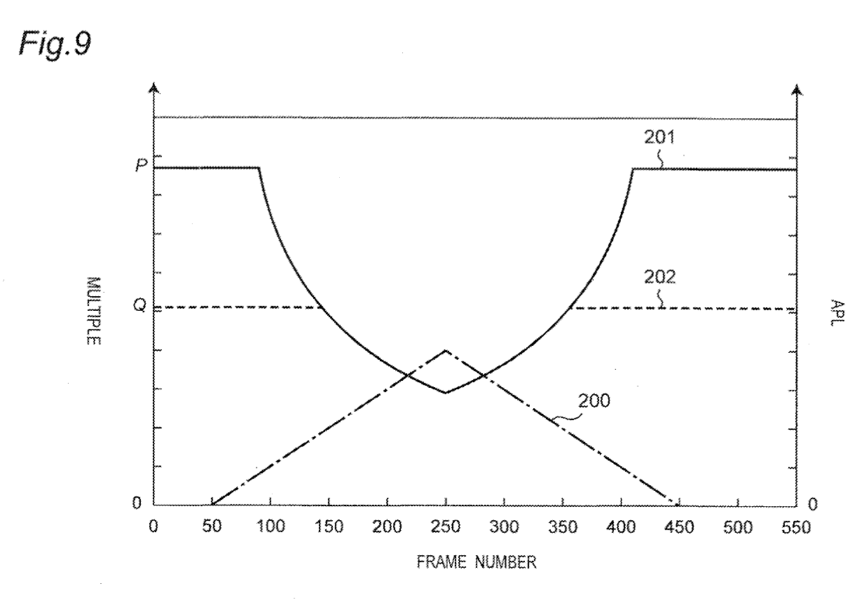

Changing the multiple in a display device according to this embodiment of the invention is described next. FIG. 9 shows an example of multiple change when there is no change in the ambient brightness of the display device. The frame number is shown on the x-axis, the multiple is shown on the left y-axis, and the APL is shown on the right y-axis. Dot-dash line 200 shows the APL value 200. In this example the APL value 200 is 0 until frame 50, increases at a constant rate from frame 50 to frame 250, decreases at a constant rate from frame 250 to frame 450, and is 0 from frame 450.

Solid line 201 denotes change in the multiple (multiple 1) of the first mode (when the display device surroundings are bright). Because multiple 1 is a constant P when the APL is less than a specific value, multiple 1 is the constant P until frame 90. Multiple 1 then decreases in conjunction with the increase in the APL from frame 90 to frame 250, then conversely increases in conjunction with the decrease in APL from frame 250 to frame 410, an from frame 410 is the constant P.

Dotted line 202 denotes change in the multiple (multiple 2) of the second mode (when the display device surroundings are dark). Dotted line 202 is coincident with dotted line 201 from frame 145 to frame 355. Because multiple 2 is constant Q (<P) while the APL is less than a second specific value (>first specific value), multiple 2 is constant Q to frame 145. Multiple 2 decreases with the rise in the APL from frame 145 to frame 250, increases with the decrease in APL from frame 250 to frame 355, and is the constant Q from frame 355.

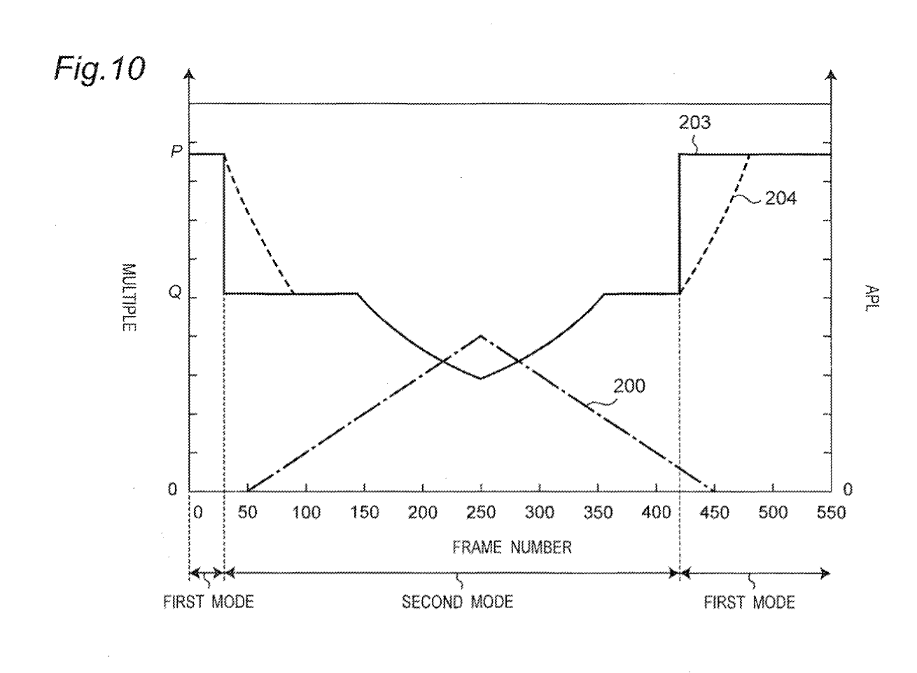

FIG. 10 shows an example of multiple change when the ambient brightness of the display device changes. The x-axis and y-axes are the same as shown in FIG. 9. The dot-dash line 200 denotes the APL. The APL value 200 changes as shown in FIG. 9. The first mode (display device surroundings are bright) is active until frame 30, the second mode (display device surroundings are dark) is active from frame 30 to frame 420, and the first mode is active again (display device surroundings are bright) from frame 420.

Solid line 203 denotes change in the multiple of a conventional display device. The multiple is the constant P to frame 30, but drops suddenly to value Q at frame 30 because the ambient brightness changes from the first mode to the second mode, and remains the constant Q from frame 30 to frame 145. From frame 145 to frame 355, the multiple changes according to the APL. The multiple is the constant Q from frame 355 to frame 420, but because the ambient brightness changes from the second mode to the first mode at frame 420, the multiple increases abruptly to constant P and remains the constant P from frame 420. Because the multiple changes suddenly when the mode changes (at frame 30 and frame 420), the screen of the display device according to the related art flickers.

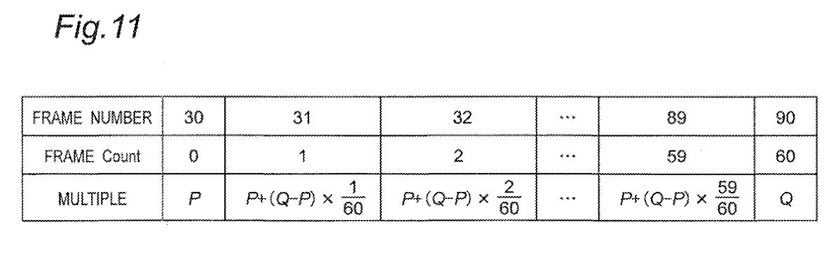

Dotted line 204 shows the change in the multiple in a display device according to this embodiment of the invention. Dotted line 204 is coincident with solid line 203 to frame 30, from frame 90 to frame 420, and from frame 480. The multiple is constant P to frame 30. At frame 30 the ambient brightness changes from the first mode to the second mode. Because Coef is set to a specific value of 60, the multiple is changed gradually from multiple 1 (P) to multiple 2 (Q) during the 60 frames from frame 30 to frame 90. FIG. 11 shows this change in the multiple from frame 30 to frame 90 in FIG. 10 in detail. In frame 30 where the first mode changes to the second mode, the frame number Count is the default value of 0, and the multiple is P. At frame 31, the frame number Count becomes 1, and the multiple changes to (P+(Q−P)× 1/60). The multiple continues changing the same way in frame 32, frame 33 and so forth to frame 89 where the frame number Count becomes 59 and the multiple changes to (P+(Q−P)× 59/60). In frame 90 the frame number Count goes to 60 and the multiple goes to Q.

Returning to FIG. 10, the multiple changes in the same was as in the display device according to the related art from frame 90 to frame 420. Because the brightness changes from the second mode to the first mode at frame 420, the multiple changes from multiple 2Q to multiple 1P during the 60 frames from frame 420 to frame 480. The multiple is the constant P from frame 480.

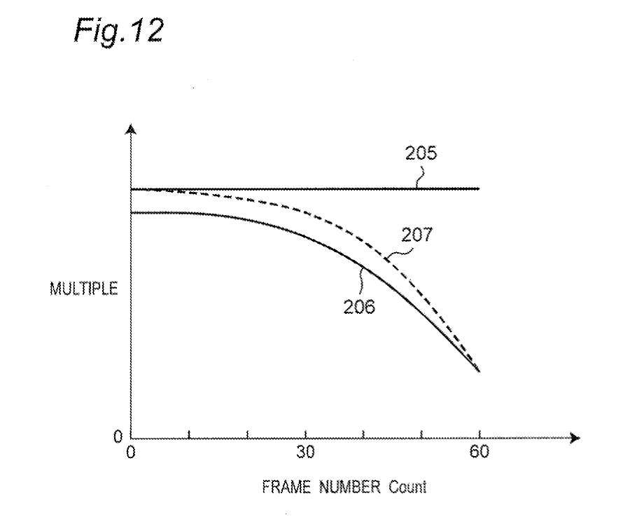

FIG. 10 shows an example in which multiple 1 and multiple 2 are both constant while the multiple is changing (from frame 30 to frame 90, and from frame 420 to frame 480). FIG. 12 shows an example of multiple change in which the second mode multiple varies while the multiple changes. The ambient brightness changed from the first mode to the second mode at frame number Count 0. Solid line 205 shows the multiple change in the first mode (when the display device surroundings are bright), solid line 206 shows the multiple change in the first mode (when the display device surroundings are dark), and dotted line 207 shows the multiple change in a display device according to this embodiment of the invention. By using the equations shown in step S24 and step S25 in FIG. 5 when changing the multiple, the multiple can be changed from multiple 1 to multiple 2 in the frame count set to Coef even if multiple 1 and multiple 2 vary.

A configuration that detects the ambient brightness of the display device and turns the viewing environment detection function that changes the mode based on the detected ambient brightness on and off is also conceivable. The mode is changed manually when the viewing environment detection function is off, but when the mode is changed manually, the multiple can be changed suddenly from the multiple of the mode before the mode change to the multiple of the mode after the mode change.

As described above, a display device according to this embodiment of the invention can automatically change the mode according to the ambient brightness. When the mode changes automatically, the display device according to this embodiment of the invention can also gradually change the multiple from the multiple of the mode before the mode change to the multiple of the mode after the mode change. The brightness of the display screen therefore does not change suddenly and there is no flickering even when the mode changes automatically. Yet further, because the display device according to this embodiment of the invention changes the multiple gradually using the equations shown in step S24 and step S25 in FIG. 5, the multiple can be changed over the number of frames set by Coef from the multiple of the mode before the mode change to the multiple of the mode after the mode change.

### Embodiment 2

This embodiment of the invention describes a display device that adds a process of correcting the time (Coef) during which the multiple changes according to the difference between the multiple of the mode before the mode change and the multiple of the mode after the mode change, and the frequency component of the video data.

### Configuration of the Display Device

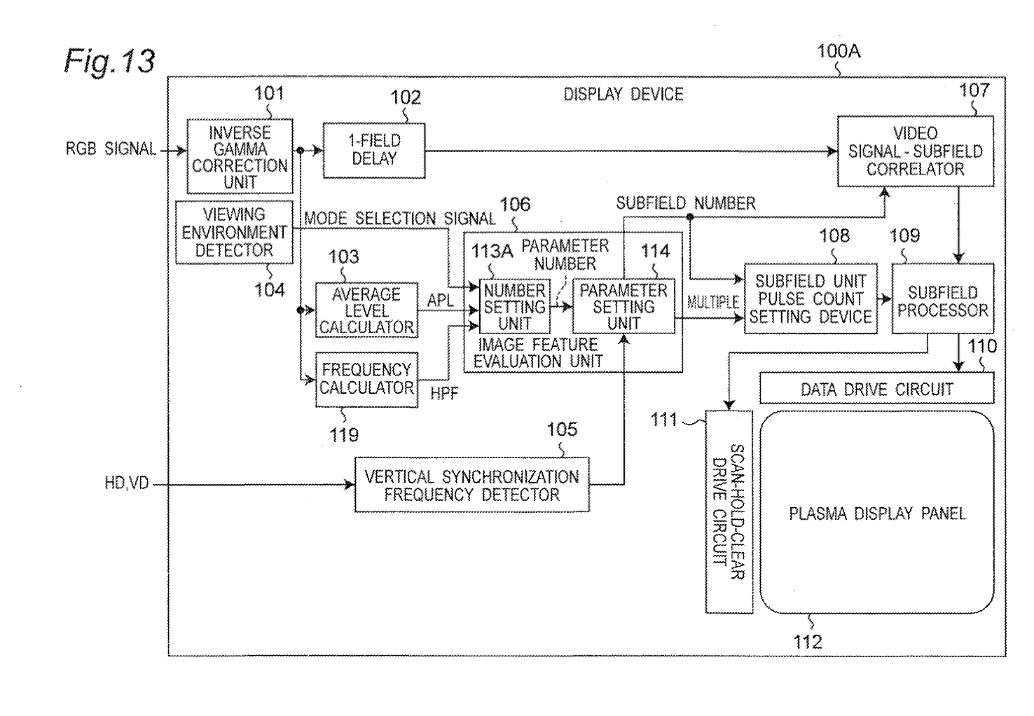

FIG. 13 is a block diagram showing the configuration of a display device according to a second embodiment of the invention.

The display device 100A according to this embodiment of the invention adds a frequency calculator 119 to the configuration of the display device 100 according to the first embodiment of the invention. The frequency calculator 119 calculates the frequency component of an inverse-gamma corrected RGB signal.

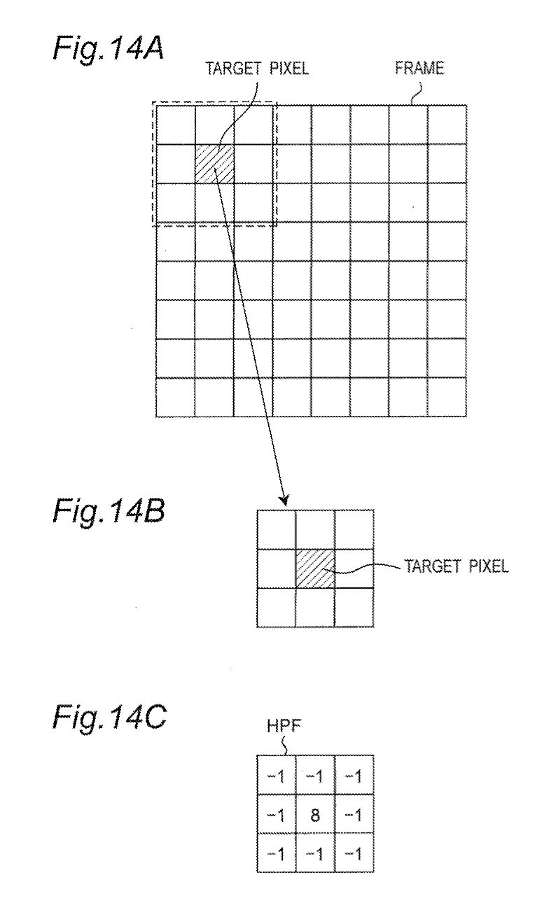

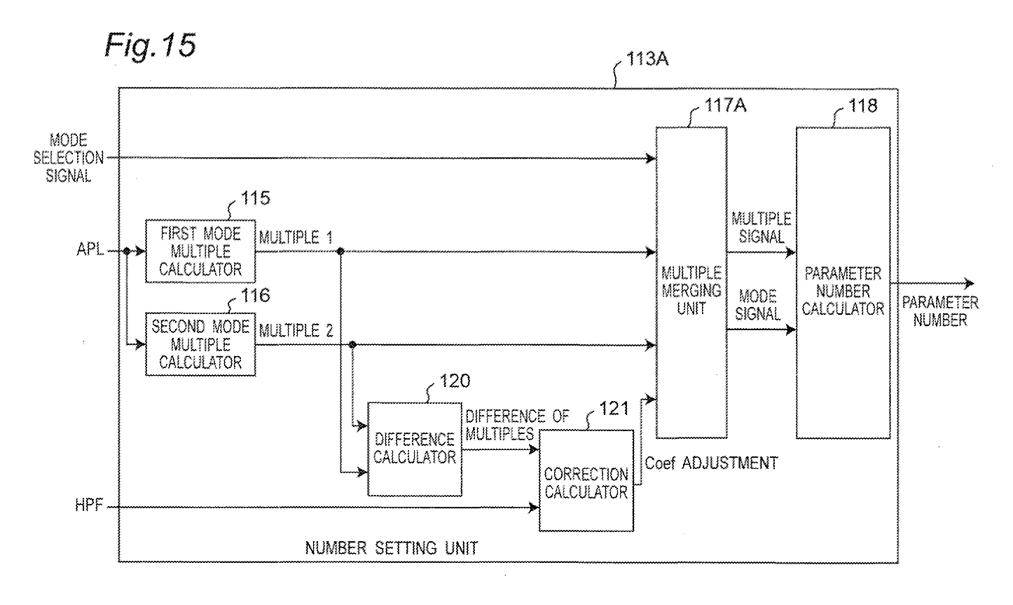

More specifically, the frequency calculator 119 extracts a 3×3 pixel block (FIG. 14B) centered on a target pixel in a particular frame (FIG. 14A). The extracted block of 3×3 pixels has the same number of pixels as a filter. A high pass filter (HPF) such as shown in FIG. 14C is applied to the extracted block to obtain the HPF value of one pixel. By applying this process to each pixel in the frame, the HPF value is obtained for all pixels in the frame, and the sum thereof is output as the frequency component. The number setting unit 113A determines the parameter number based on the APL from the average level calculator 103, the mode selection signal from the viewing environment detector 104, and the HPF values from the frequency calculator 119 as described with reference to FIG. 15.

### Coef Correction Process

FIG. 15 is a block diagram showing the configuration of the number setting unit 113A in FIG. 13 in detail. This number setting unit 113A adds a difference calculator 120 and a correction calculator 121 to the number setting unit 113 in the first embodiment.

The difference calculator 120 subtracts multiple 2 from multiple 1, and outputs the absolute value of the difference.

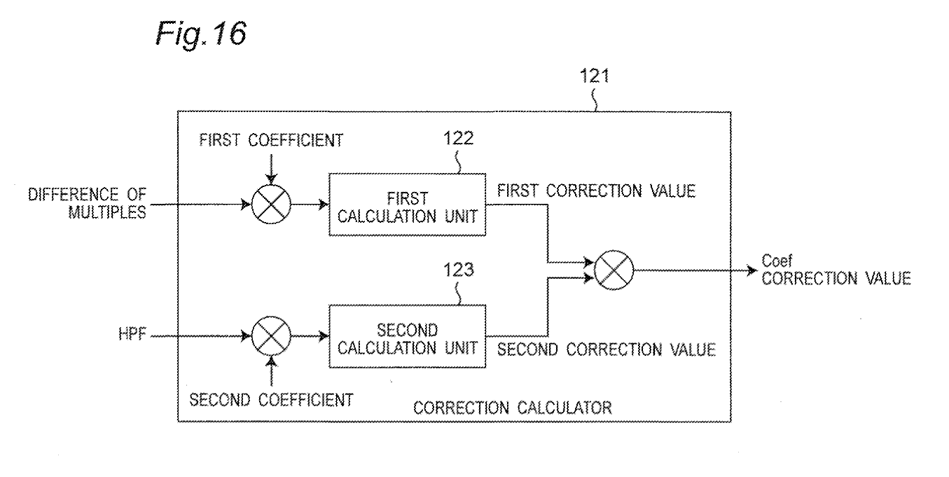

The correction calculator 121 obtains Coef correction from the difference between multiple 1 and multiple 2 and the HPF value (described in FIG. 16). The multiple merging unit 117A corrects Coef, and runs the multiple merging process using the corrected Coef.

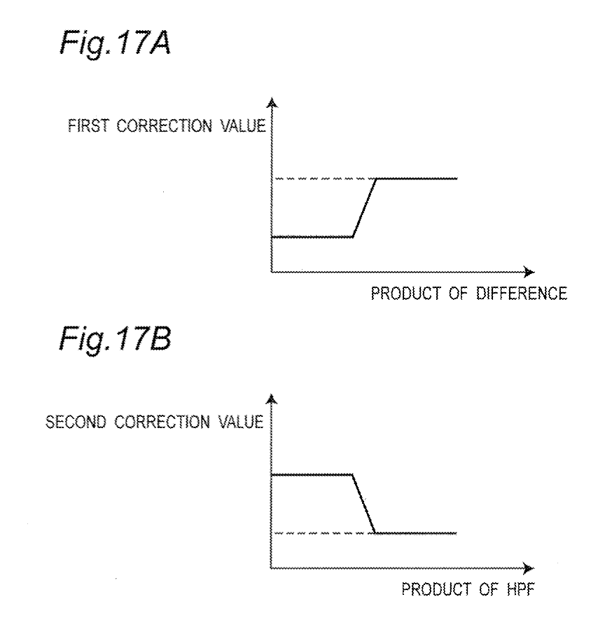

FIG. 16 is a block diagram showing the detailed configuration of the correction calculator 121 in FIG. 15. The correction calculator 121 multiplies the difference between multiple 1 and multiple 2 received from the difference calculator 120 by a first coefficient, and inputs the product to a first calculation unit 122. The first calculation unit 122 uses a function such as shown in FIG. 17A to obtain a first correction value from the input product of the difference. The correction calculator 121 likewise multiplies the HPF value from the frequency calculator 119 by a second coefficient, and inputs the product to a second calculation unit 123. The second calculation unit 123 uses a function such as shown in FIG. 17B to obtain a second correction value from the input product of the HPF value. The first correction value and the second correction value are then multiplied together to get the Coef correction value.

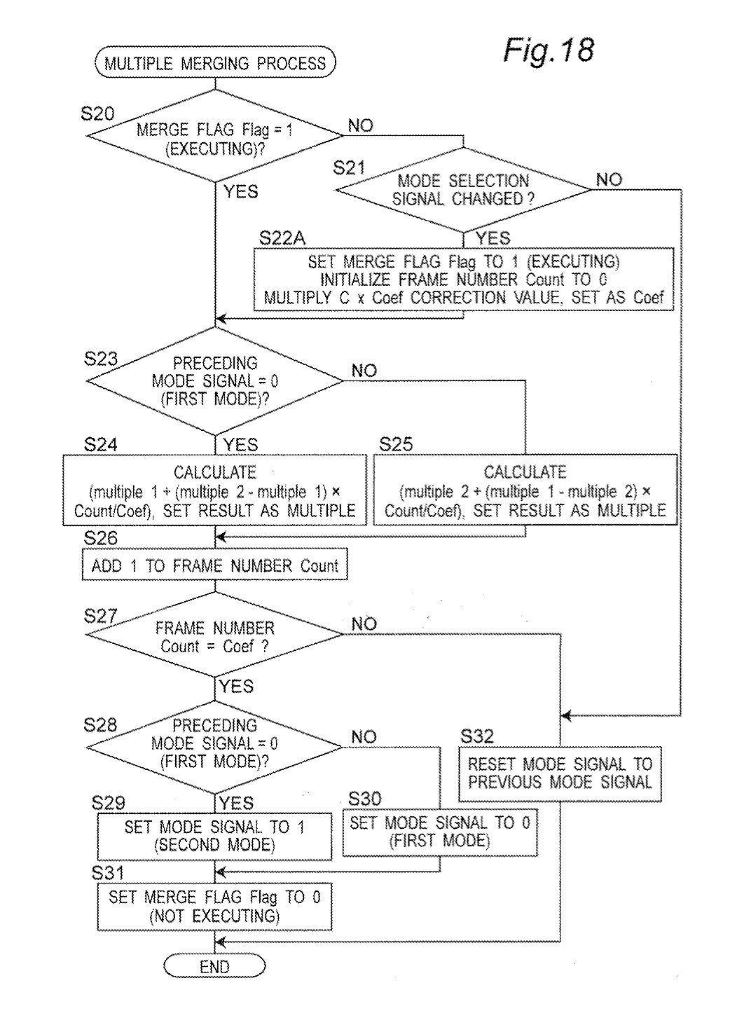

FIG. 18 is a flow chart of the multiple merging process of the display device according to the second embodiment of the invention. If the merge flag Flag is 0 (not executing) and the mode selection signal changes (S20 returns No, and S21 returns Yes), the multiple merging unit 117A starts the merging process (S22A). More specifically, the merge flag Flag is set to 1 (executing), the frame number Count is initialized to the default value 0, the Coef correction is multiplied by a specific value C, and this product is set as Coef. Subsequent steps are the same as in the multiple merging process of the first embodiment (FIG. 5), and further description thereof is thus omitted.

The Coef correction is calculated from a first correction value and second correction value in the display device according to this embodiment of the invention, but either correction value may be set as the Coef correction.

The display device according to this embodiment of the invention corrects Coef according to frequency component of the video data and the difference of the multiple of the mode before the mode change and the multiple of the mode after the mode change, but Coef may be corrected according to the APL.

As described above, by correcting Coef, the display device according to this embodiment of the invention changes the time during which the screen brightness changes from the brightness of the display screen before the mode change to the brightness of the display screen after the mode change based on the video data. More specifically, the time used to change the brightness of the display screen increases when the difference between the brightness of the display screen before the mode change and the brightness of the display screen after the mode change is great, and shortens the time when the difference is small. The brightness of the display screen changes over a short time when the image is complex because changes in screen brightness are not readily noticed, but the brightness of the display screen changes over a longer period in simple images of solid colors because changes in screen brightness are readily noticed. As a result, the viewer is less likely to notice the change in the brightness of the display screen.

### APPLICATION IN INDUSTRY

A display device according to the invention can be used as a display device that can automatically change the display mode without causing the display screen to flicker.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

1. A display device that has plural display modes, comprising:
a screen brightness calculator that calculates the brightness of the display screen in each mode based on the average brightness of video data in one frame; and
a screen brightness merger that, when the mode changes, gradually changes the brightness of the display screen from the brightness of the display screen before the mode change to the brightness of the display screen after the mode change.

2. The display device described in claim 1, further comprising:
a viewing environment detector that detects the ambient brightness and changes the mode based on the detected ambient brightness.

3. The display device described in claim 1, wherein:
the screen brightness merger changes the brightness of the display screen from the brightness before the mode change to the brightness of the display screen after the mode change over a specified time.

4. The display device described in claim 1, wherein:
the screen brightness merger adjusts the time used to change the brightness of the display screen from the brightness of the display screen before the mode change to the brightness of the display screen after the mode change according to the average brightness of the video data in one frame.

5. The display device described in claim 4, wherein:
the screen brightness merger adjusts the time used to effect the change when the average brightness of video data in one frame is greater than or equal to a first specific value to shorter than the time used to effect the change when the average brightness of video data in one frame is less than the first specific value.

6. The display device described in claim 1, wherein:
the screen brightness merger adjusts the time used to change the brightness of the display screen from the brightness of the display screen before the mode change to the brightness of the display screen after the mode change according to the difference between the brightness of the display screen before the mode change and the brightness of the display screen after the mode change.

7. The display device described in claim 6, wherein:
the screen brightness merger adjusts the time used to effect the change when the difference between the brightness of the display screen before the mode change and the brightness of the display screen after the mode change is greater than or equal to a second specific value to longer than the time used to effect the change when the average brightness of video data in one frame is less than the second specific value.

8. The display device described in claim 1, wherein:
the screen brightness merger adjusts the time used to change the brightness of the display screen from the brightness of the display screen before the mode change to the brightness of the display screen after the mode change according to a frequency component of the video data.

9. The display device described in claim 8, wherein:
the screen brightness merger adjusts the time used to effect the change when the frequency component of the video data is greater than or equal to a third specific value to shorter than the time used to effect the change when the frequency component of the video data is less than the third specific value.

10. The display device described in claim 1, wherein:
the screen brightness merger immediately changes the brightness of the display screen from the brightness of the display screen before the mode change to the brightness of the display screen after the mode change when the mode is changed manually.

11. A display method for a display device that has plural display modes, comprising:
a screen brightness calculation step of calculating the brightness of the display screen in each mode based on the average brightness of video data in one frame; and
a screen brightness merging step of gradually changing the brightness of the display screen from the brightness of the display screen before the mode change to the brightness of the display screen after the mode change when the mode changes.
